(19) United States
(12) Patent Application Publication
(10) Pub. No.: US 2011/0179062 A1
(43) Pub. Date: Jul. 21, 2011

(54) APPARATUS AND METHOD FOR SHARING SOCIAL MEDIA CONTENT

(75) Inventors: Hoon Ki LEE, Daejeon (KR); Jong-Hoon LEE, Daejeon (KR); Jung Tae KIM, Daejeon (KR); Euihyun PAIK, Daejeon (KR)

(73) Assignee: Electronics and Telecommunications Research Institute, Daejeon (KR)

(21) Appl. No.: 12/907,464

(22) Filed: Oct. 19, 2010

(30) Foreign Application Priority Data
Jan. 19, 2010 (KR) 10-2010-0004703
Jun. 7, 2010 (KR) 10-2010-0053385

(51) Int. Cl. G06F 17/30

(52) U.S. Cl. 707/769; 707/E17.014

(57) ABSTRACT

An apparatus for sharing social media content includes a content management unit for, when sharable content is input by a user, extracting profile information about the sharable content by analyzing the sharable content, and generating social media content by associating the extracted profile information about the sharable content with profile information about a user to store the generated social media content in a database. Further, the apparatus for sharing the social media content includes a content searching unit for extracting an initial sample by searching the database based on keywords requested to be searched for in response to a search request of a user, and searching for the sample by comparing profile information about each piece of content included in the initial sample with one of the keywords.

### CROSS-REFERENCE TO RELATED APPLICATION(S)

The present invention claims priority of Korean Patent Application No. 10-2010-0004703, filed on Jan. 19, 2010, and Korean Patent Application No. 10-2010-0053385, filed on Jun. 7, 2010, which are incorporated herein by references.

### FIELD OF THE INVENTION

The present invention relates to sharing social media content; and, more particularly, to an apparatus and method for sharing social media content, which stores sharable content by associating profile information about a user with profile information about the sharable content, and provides the results of searching for content using information about social content associated with the content as well as the relationship between the profile information about the user and a keyword.

### BACKGROUND OF THE INVENTION

With the latest developments in communication technology, new types of multimedia content services, such as digital broadcasting, Digital Multimedia Broadcasting (DMB), and Internet Protocol Television (IPTV), have appeared, so that multimedia data, including the multimedia content desired by a user as well as simple data obtained from conventional web pages or web documents, has been shared by a plurality of users. The conventional method of sharing data includes a method of sharing servers/clients using File Transfer Protocol (FTP) and a method of users sharing a specific folder using Peer-to-Peer (P2P).

Meanwhile, the necessity of searching for multimedia data in which shared data can be easily searched for has increased. A searching method based on a file name has been widely generalized and used.

In such a conventional method of searching for shared data, data is searched for based on a file name and then the found data is processed, or the data is processed after the downloading thereof has been completed, thereby checking whether the data desired by the user has been downloaded. That is, it cannot be ascertained whether the shared data includes the information desired by the user if the data is simply downloaded, so that there is a problem in that the user needs to directly process a file after completing the downloading of the file.

Meanwhile, from the point of view of a sharer who shares data, the sharer may want to add various types of information thereto to provide information about the data shared by her or him, but there is a disadvantage in that only the file name desired to be shared may generally be changed.

For these reasons, there is a problem in that a user downloads data which the user does not need, so that excess packets are consumed and network traffic is increased.

### SUMMARY OF THE INVENTION

In view of the above, the present invention provides an apparatus and method for sharing social media content, which stores sharable content by associating profile information about a user with profile information about the sharable content, so that the user can add desired information to the content when the user shares the content.

Further, the present invention provides an apparatus and method for sharing social media content, which provides the results of searching for content using information about social content associated with the content as well as the relationship between profile information about the user and a keyword, so that more accurate search results can be provided to the user.

In accordance with a first aspect of the present invention, there is provided an apparatus for sharing social media content including: a content management unit for, when sharable content is input by a user, extracting profile information about the sharable content by analyzing the sharable content, and generating social media content by associating the extracted profile information about the sharable content with profile information about a user to store the generated social media content in a database; and

a content searching unit for extracting an initial sample by searching the database based on keywords requested to be searched for in response to a search request of a user, and searching for the sample by comparing profile information about each piece of content included in the initial sample with one of the keywords.

In accordance with a second aspect of the present invention, there is provided a method of sharing social media content, the method of sharing content using an apparatus for sharing social media content having a database for storing profile information about each of a plurality of users, and the method including: receiving sharable content from a user; extracting property information and information about social content of the sharable content from the sharable content to store the extracted information in a database; extracting profile information about the user from the database; and generating social media content by associating profile information about the sharable content having the property information and the information about social content, the sharable content, and the profile information about the user to store generated social media content in the database.

In accordance with an embodiment of the present invention, the sharable content is stored by associating the profile information about the user with the profile information about the sharable content, so that the user can add desired information to content when the user shares the content, thereby improving the reliability of sharing the sharable content.

Further, the results of searching for the content is provided using the information about the social content associated with the content and the relationship between the profile information about the user and the keyword, so that more accurate search results can be provided to the user and network traffic can be eased by reducing the number of unnecessary searches.

### BRIEF DESCRIPTION OF THE DRAWINGS

The objects and features of the present invention will become apparent from the following description of embodiments given in conjunction with the accompanying drawings, in which:

FIG. 1 is a block diagram of an apparatus for sharing social media content based on location/social relationship in accordance with an embodiment of the present invention;

FIGS. 2A and 2B are views showing examples for describing profile information about content in accordance with the embodiment of the present invention;

FIG. 3 is a view showing an example for describing profile information about a user in accordance with the embodiment of the present invention;

FIG. 4 is a flow chart showing a process of generating social media content in accordance with the embodiment of the present invention; and

FIG. 5 is a flow chart showing a process of searching for social media content in accordance with the embodiment of the present invention.

### DETAILED DESCRIPTION OF THE EMBODIMENTS

Embodiments of the present invention will be described in detail with reference to the accompanying drawings which form a part hereof.

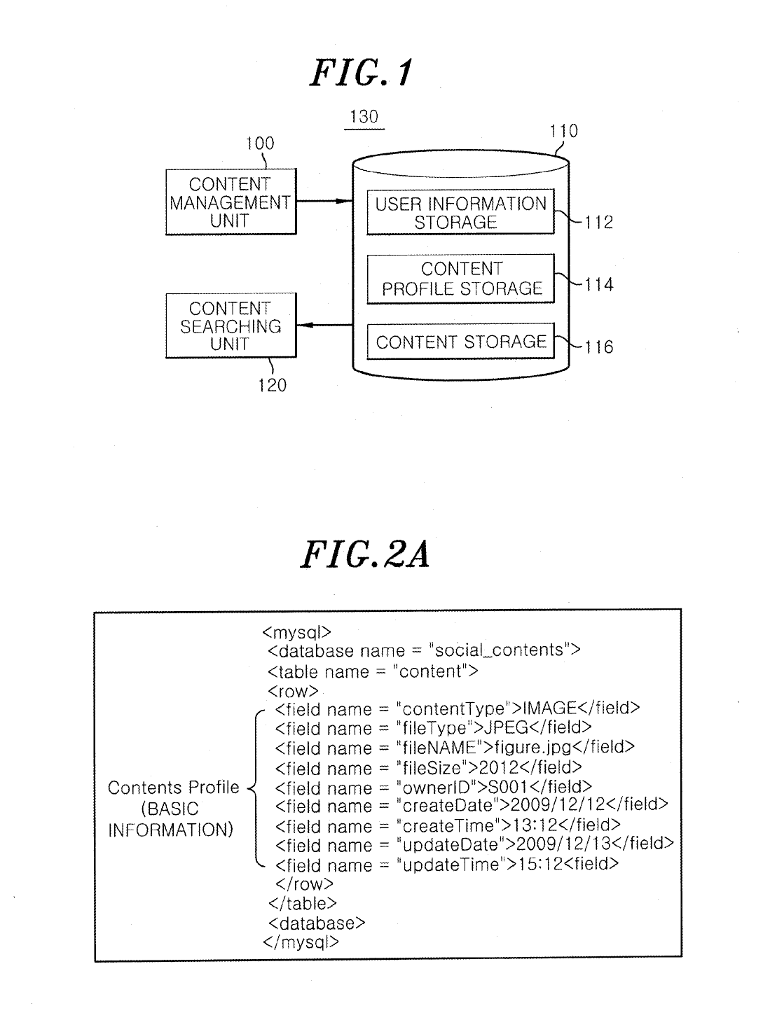

FIG. 1 is a block diagram of an apparatus for sharing social media content 130 based on location/social relationship in accordance with an embodiment of the present invention. The apparatus for sharing social media content includes a content management unit 100, a database 110 and a content searching unit 120. The database 110 includes user information storage 112, content profile storage 114, and content storage 116.

When sharable content desired to be shared by a user is input, the content management unit 100 generates social media content by associating profile information about sharable content with profile information about the user, and stores the generated social media content in the database 110.

Specifically, the content management unit 100 extracts location information of the user who input the sharable content; and generates the social media content by associating the profile information about the sharable content, the sharable content, the profile information about the user and the location information of the user to store generated social media content in the database.

When the social media content is generated using the sharable content, the content management unit 100 can generate the social media content by adding the profile information about the user used for information about location/social relationship.

Here, social media content includes profile information having property information about the sharable content and information about social content necessary for when the user uploads and shares the content, and the profile information about the user.

The profile information about the user may include user property information, such as psychographics, from among information about social relationship-based ontology and various types of information required for each user to solve a problem. Further, the profile information about each user who uses the apparatus for sharing the social media content is stored in the user information storage 112.

Such profile information about the user is extracted from the user information storage 112, that is, the content management unit 100 extracts the profile information about the user who input the sharable content from the user information storage 112.

As described above, the content management unit 100 in accordance with an embodiment of the present invention generates the social media content, including the sharable content, the profile information about the sharable content, and the profile information about the user, and then stores the generated social media content in the content storage 116. Here, the profile information about the sharable content may be stored in the form of a tag list. That is, since each piece of sharable content may include a plurality of tags, the same tag may be connected to entirely different sharable content.

The content searching unit 120 searches the database 110 based on keywords requested to be searched for in response to a search request of the user, extracts the results of searching for a sample, generates the search results by comparing profile information about the user, included in the results of the searching for the sample, with profile information about the user who requested that the search be performed, and then provides the generated search results to the user.

Further, the content searching unit 120 generates the search results by comparing the location information of the user who requested that the search be performed with the location information of the social media content included in the results of searching for the sample.

The information about social content may be extracted by analyzing information included in the sharable content or may be extracted by using information received from the user. In other words, the content management unit 100 may provide an input interface capable of receiving information about the social content of the sharable content as input, and may extract the information about social content using data received through the input interface.

An example of a method of extracting information about the social content by analyzing information will be described. First, when the sharable content corresponds to a music file, such as a Moving Picture Experts Group Audio Layer-3 (MP3), information about the social content can be extracted by analyzing a text file connected to each file, when the sharable content corresponds to a video file, information about the social content can be extracted by analyzing a superimposed caption file connected to the video file, and when the sharable content corresponds to a text file, the information about social content can be extracted by analyzing the context of the text file.

The property information about the sharable content and the information about the social content which have been extracted through the above-described process, are stored in the content profile storage 114.

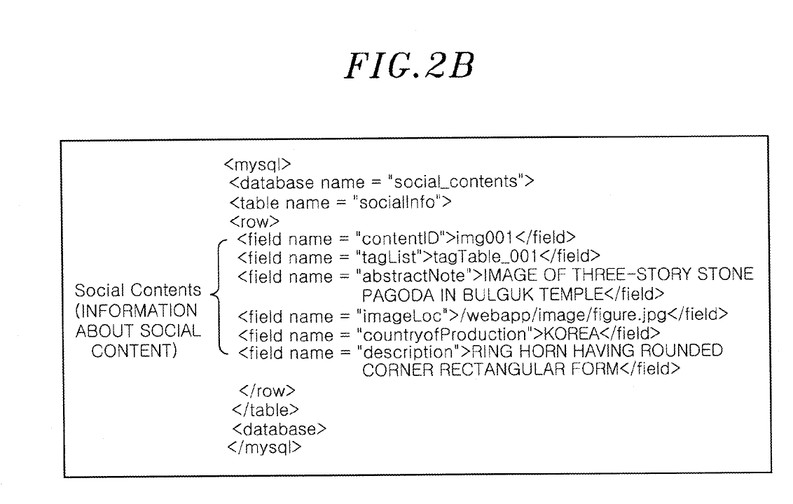

The property information about content and information about the social content, which are included in the profile information about the sharable content, will be described with reference to FIGS. 2A and 2B.

As shown in FIGS. 2A and 2B, the social media content can be categorized and managed for the purposes of easy storage and searching thereof using social tagging and information fields as well as basic information about the file.

FIG. 2A shows property information about media content, such as the basic information scheme of the content. The apparatus for sharing the social media content manages the initial information related to the media content by profiling it, so that content having the same file name can be managed as separate files. Here, the basic information about the content includes the type of content, the type of file, the size of the file, user Identification (ID), the date on which the file is created, the time at which the file is created, the data on which the file is updated, and the time at which the file is updated.

Further, the social media content requires information about social content, which is additional data to analyze semantic information. Here, as shown in FIG. 2B, the information about the social content includes a content ID, a tag list, an abstract note, an image location, the country of production, and description information.

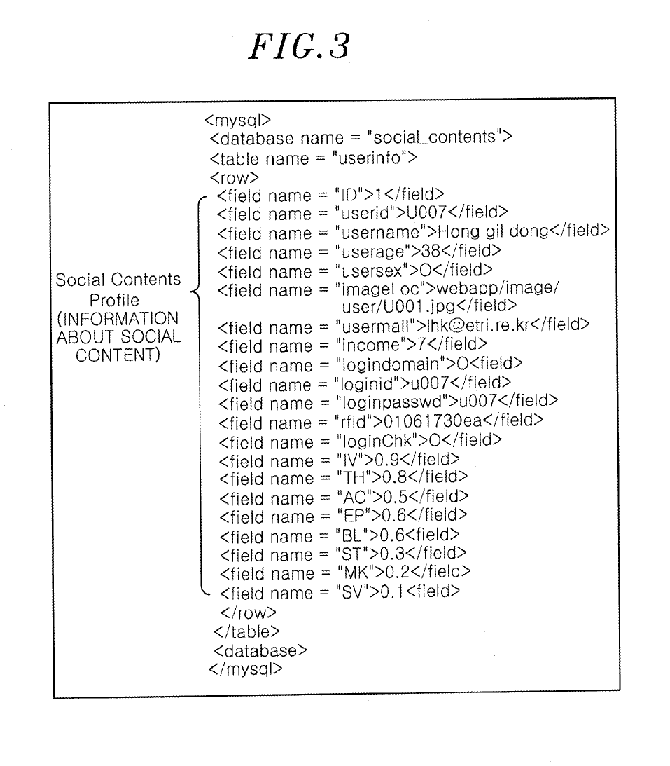

As shown in FIG. 3, the user property information may be obtained using a method, such as psychographics, that is, may be obtained based on Values, Attitudes, and Life Styles (VALS). In other words, the user property information may be obtained using information about searches frequently performed by the user, information about web sites frequently visited by the user, and the tastes and inclinations of the user based on the user's age, hobbies and special skills.

Further, in accordance with the embodiment of the present invention, the user property information is configured and provided to have eight fields, as shown in FIG. 3. Here, the eight fields may include an Innovator (IV) field, a Thinker (TH) field, an Achiever (AC) field, an Experience (EP) field, a Believer (BL) field, a Striver (ST) field, a Maker (MK) field, and a Survivor (SV) field.

The information about social relationship-based ontology of the profile information about the user may be configured using information input when the user becomes a member to use the apparatus for the sharing social media content, for example, information about the age, sex, and area of residence of the user.

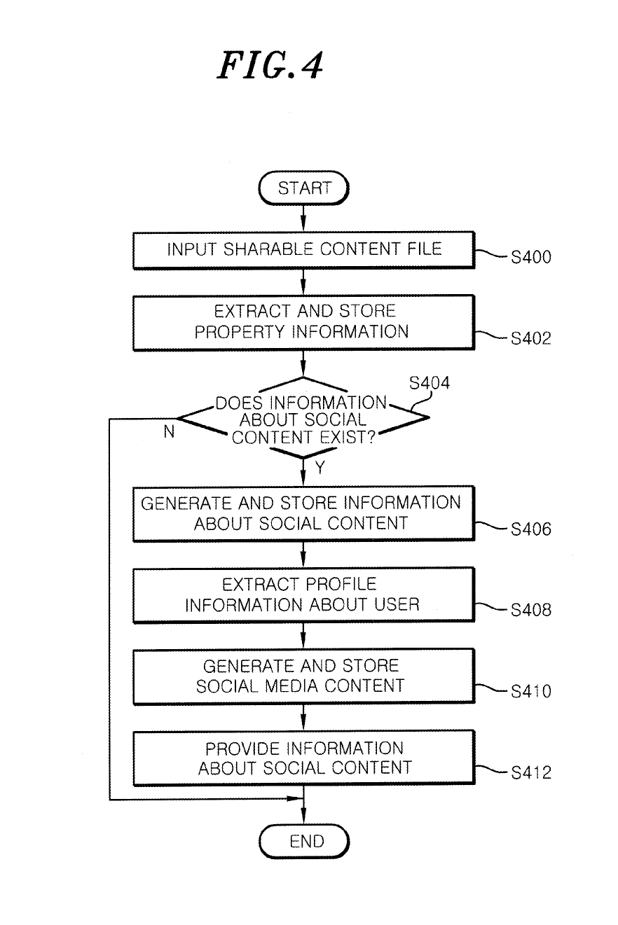

The process by which the content generation unit (not shown) of the apparatus for sharing the social media content having the above-described configuration generates social media content will be described with reference to FIG. 4.

FIG. 4 is a flow chart showing the process of generating the social media content in accordance with an embodiment of the present invention.

As shown in FIG. 4, the service is made available when the user accesses the apparatus for sharing the social media content, and the user inputs user information and a sharable content file desired to be uploaded in step S400. In other words, the user accesses the apparatus for sharing the social media content, performs a log-in process, and then inputs the sharable content file desired to be uploaded.

The content management unit 100 extracts the property information of the sharable content file by analyzing the sharable content file, and stores the extracted property information of the sharable content file in the content profile storage 114 in step S402. That is, the content management unit 100 extracts the property information of the sharable content file, as shown in FIG. 2A, and then stores the property information of the sharable content file in the content profile storage 114.

Thereafter, the content management unit 100 determines whether information about social content, which is additional information about content, exists in step S404.

If, as a result of the determination in step S404, the information about the social content exists, the content management unit 100 generates the information about the social content as shown in FIG. 2B by analyzing the sharable content file or the information input by the user, and stores the generated information about the social content in the content profile storage 114 in step S406.

Thereafter, the content management unit 100 extracts the profile information about the user from the user information storage 112 in step S408, generates the social media content, including the sharable content, the property information stored in the content profile storage 114, one or more tags connected to the information about the social content and the extracted profile information about the user, and then stores the generated social media content in the content storage 116 in step S410. Here, the social media content may be stored in the content storage 116 in the form of an information dictionary which is required when the process of processing a high-capacity database is performed. Here, the information dictionary is stored so that it can be previously searched by using an ontology and the database 110.

Further, the content management unit 100 provides the information about the social content, extracted during the process of generating the social media content, to the user in step S412. Therefore, the user can check whether the sharable content file of the user desired to be uploaded has been properly registered.

Although not shown in the drawing, if, as a result of the determination in step S404, the information about the social content does not exist, the content management unit 100 stores the property information of the sharable content file and the sharable content file in the content storage 116, and the sharable content file stored in the content storage 116 is used to conduct a search based on the file name.

In accordance with the embodiment of the present invention, the sharable content is stored after the sharable content has been associated with the profile information about the user and the profile information about the sharable content, so that the user can input his/her desired information when the user shares content.

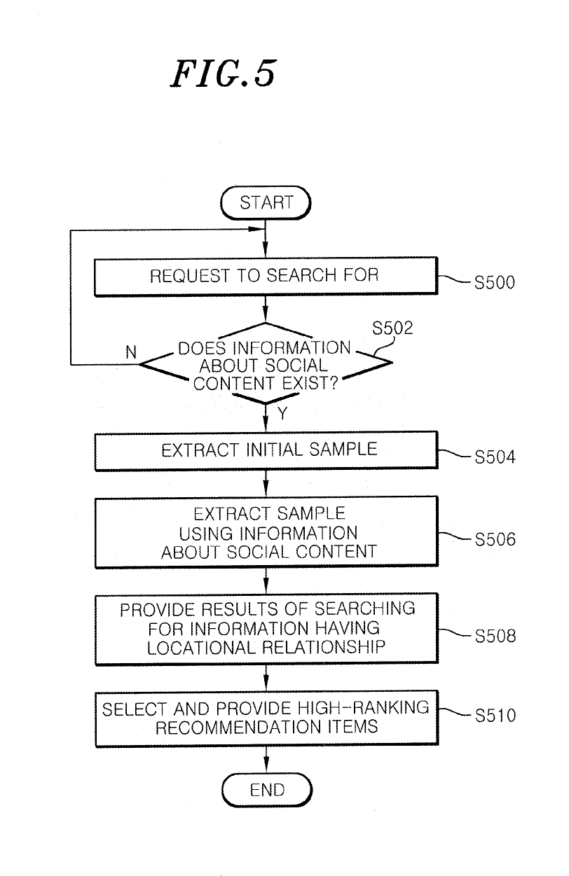

The process of the content searching unit 120 searching for location/social relationship-based social media content will be described with reference to FIG. 5.

FIG. 5 is a flow chart showing the process of searching for the social media content in accordance with the embodiment of the present invention.

First, as shown in FIG. 5, the user accesses the apparatus for sharing the social media content, and requests that a search be performed by inputting keywords in step S500.

The content searching unit 120 performs a basic search based on the property information associated with each piece of social media content stored in the content storage 116, and determines whether the social media content associated with the keyword exists in the content storage 116 in step S502.

If, as a result of the determination in step S502, the corresponding social media content exists, the content searching unit 120 extracts an initial sample including the social media content related to the keyword in step S504.

Thereafter, the content searching unit 120 searches the content profile storage 114 for the information about the social content for each of the social media content selected as the extracted initial sample, compares the found information about the social content with the keyword, and then extracts the results of the search which has high degree of similarity between the found information about the social content with the keyword as the sample in step S506.

Thereafter, in order to search for the information more reliably, the content searching unit 120 searches the user information storage 112 for location information associated with the each piece of the social medial content extracted as the sample, supplements a location relationship by comparing the found location information with the location information of the user who requested that the search be performed, and then provides the results of searching for information including the social media content having a locational relationship in step S508.

Thereafter, the content searching unit 120 extracts psychographics information, such as the inclinations and interests of the user who requested that the search be performed, from the user information storage 112, selects high-ranking recommendation items from the results of searching for information by processing the patterns of the extracted psychographics information and the results of searching for the information, and then provides the high-ranking recommendation items to the user who requested that the search be performed in step S510.

Meanwhile, if, as a result of the determination in step S502, the social media content corresponding to the keyword does not exist, the content searching unit 120 returns to step S500 and requests the input of a new keyword.

While the invention has been shown and described with respect to the embodiments, it will be understood by those skilled in the art that various changes and modification may be made without departing from the scope of the invention as defined in the following claims.

What is claimed is:

1. An apparatus for sharing social media content comprising:
a content management unit for, when sharable content is input by a user, extracting profile information about the sharable content by analyzing the sharable content, and generating social media content by associating the extracted profile information about the sharable content with profile information about a user to store the generated social media content in a database; and
a content searching unit for extracting an initial sample by searching the database based on keywords requested to be searched for in response to a search request of a user, and searching for the sample by comparing profile information about each piece of content included in the initial sample with one of the keywords.

2. The apparatus of claim 1, wherein the database includes:
a user information storage for storing the profile information about the user;
a content profile storage for storing property information of the sharable content; and
a content storage for storing the social media content.

3. The apparatus of claim 1, wherein the content management unit extracts the profile information about each of a plurality of the user who use the apparatus for sharing the social media content from a user information storage.

4. The apparatus of claim 3, wherein the content management unit collects the profile information about the user using a psychographics method to store the profile information about the user in the user information storage.

5. The apparatus of claim 3, wherein the user information storage stores information about interests and inclinations of the plurality of users in a form of the profile information.

6. The apparatus of claim 5, wherein the content searching unit searches the user information storage for profile information about the user, and provides high-ranking recommendation items to the user as a result of the search by comparing the searched profile information about the user with the sample.

7. The apparatus of claim 1, wherein the profile information about the sharable content comprises property information about the sharable content and information about social content of the sharable content.

8. The apparatus of claim 7, wherein the content management unit extracts the information about the social content by analyzing the sharable content.

9. The apparatus of claim 7, wherein the content management unit provides an input interface allowing the user to input the information about social content of the sharable content, and extracts the information about the social content using data input through the input interface.

10. The apparatus of claim 7, wherein the information about the social content comprises at least one of abstract information, image location information, country information, and description information about the sharable content.

11. The apparatus of claim 1, wherein the content management unit extracts location information of the user who input the sharable content, and associates the extracted location information of the user with the sharable content to store the associated sharable content in the database.

12. The apparatus of claim 11, wherein the content searching unit generates search results by comparing the location information of the user with the location information associated with each piece of content included in the searched sample.

13. A method of sharing social media content, the method of sharing content using an apparatus for sharing social media content having a database for storing profile information about each of a plurality of users, and the method comprising:
receiving sharable content from a user;
extracting property information and information about social content of the sharable content from the sharable content to store the extracted information in a database;
extracting profile information about the user from the database; and
generating social media content by associating profile information about the sharable content including the property information and the information about social content, the sharable content, and the profile information about the user to store generated social media content in the database.

14. The method of claim 13, wherein an input interface which enables the user to input the information about social content of the sharable content is provided, and the information about social content is extracted using data input through the input interface.

15. The method of claim 13, wherein the profile information about each of the plurality of users is collected using a psychographic method and stored in the database.

16. The method of claim 13, wherein the profile information about each of the plurality of users comprises information about interests and inclinations of each of the users.

17. The method of claim 13, wherein said generating the social media content to store the social media content in the database includes:
extracting location information of the user who input the sharable content; and
generating the social media content by associating the profile information about the sharable content, the sharable content, the profile information about the user and the location information of the user to store generated social media content in the database.

18. The method of claim 17, further comprising:
searching the database based on a keyword requested to be searched for in response to a search request of the user to extract an initial sample; and
searching for the sample by comparing profile information about each piece of content included in the initial sample with the keyword.

19. The method of claim 18, further comprising:
searching the database for the profile information about the user; and
extracting high-ranking recommendation items by comparing the searched profile information about the user with the sample, and providing the high-ranking recommendation items to the arbitrary user.

20. The method of claim 18, further comprising:
searching for the location information of the arbitrary user; and
generating search results by comparing the searched location information of the user with location information associated with each piece of content included in the found sample.
